(19) United States
(12) Patent Application Publication
(10) Pub. No.: US 2006/0085840 A1
(43) Pub. Date: Apr. 20, 2006

(54) Method and apparatus for associating a client device with a hosted service

(76) Inventors: Timo Bruck, Mountain View, CA (US); Thomas R. Hammer, San Mateo, CA (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 10/966,394

(22) Filed: Oct. 14, 2004

(51) Int. Cl. H04L 9/32

(52) U.S. Cl. 726/3

(57) ABSTRACT

A set-top appliance for a video on demand service through which Internet content is available for download is identifiable through a unique identification number but becomes associated with the service (e.g., during an installation of the set-top appliance) using a pass phrase automatically generated from a database (e.g., dictionary of words and phrases) and provided to a customer of the VOD service via the set-top appliance. Use of such a pass phrase during the installation process relieves the user from having to remember the often lengthy and complex unique identification number for the set-top appliance.

### BACKGROUND OF THE INVENTION

1. Field of the Invention

The present invention relates to the fields of web-based service subscription and association of client devices with a hosted service. More specifically, the present invention relates to associating a service with unique device identification (ID) of a set-top appliance by having the service provider give the user, during service establishment, an easy-to-remember phrase created from a dictionary.

2. Description of Related Technology

The use of a unique device ID to restrict the availability of a subscription service to an authorized user or appliance is well known in the art. For example, in the cellular telephone industry, voice and data services are available to a subscriber only through a telephone handset having a Subscriber Identification Module (SIM) that is properly associated with such services. Similarly, in cable modem networks, a cable modem's ability to receive and send data over the network is restricted to devices having a properly authenticated media access control (MAC) address (e.g., associated with a paid subscription) in the service provider's database. In yet another example, services such as Movielink™ and CinemaNow™ allow downloading of their Internet content to a personal computer (PC) for viewing by associating a user and his/her service profile with a device signature obtained when authorizing the service for the first time.

In order to properly associate a user or an appliance with a subscription service, it is common for some form of installation process to be required. Usually, part of this installation process involves communicating the unique device ID to the service provider so that the service provider can associate the device, the user and the subscription in one or more databases. When the process of communicating the device ID to the service provider is performed manually, it typically involves a user reading back a string of alphanumeric characters (e.g., a MAC address or a hexadecimal serial number). This process is not user friendly and is prone to human error. When the process of communicating the device ID to the service provider is performed in an automated manner, as is the case for subscriptions to the Movielink™ and CinemaNow™ services, the user is relieved of the burden of having to read back the character string, but because the user has no visibility into the process he/she is often restricted to using only the authorized PC (i.e., having the MAC address or other identifier that was provided to the service provider) to avail him/herself of the service (e.g., browse and download content for viewing in the case of above services). This also limits the service provider's opportunity to offer subscribers access to interesting content via a web session from a non-authorized PC and directing the VOD service to send the content of interest to the authorized device.

Based on the foregoing, it will be evident that while the prior art has in general recognized the utility of unique device identification numbers for associating a service with a particular device, it lacks a system and method that is user friendly and allows a user to choose content by communicating with the service via a connection other than the authorized device.

### SUMMARY OF THE INVENTION

The present invention addresses the foregoing needs by providing, in various embodiments, a method and apparatus for associating a client device with a service.

In a first aspect of the invention, a set-top appliance identifiable with a unique identification number is associated with a hosted service (e.g., through which Internet content is available for download to the set-top appliance) using a pass phrase automatically generated from a database (for example, a dictionary of words and phrases) and provided to a customer of the hosted service via the set-top appliance. In one embodiment, the pass phrase may be organized as adjective-adjective-noun (e.g., “small-blue-kitten”).

In a second aspect of the invention, a method, including establishing a first communication session between a set-top appliance and a hosted service using a unique identifier associated with the set-top appliance; and establishing a second communication session between the hosted service and a customer thereof using a pass phrase provided to the customer as part of the first communication session is disclosed.

In a third aspect of the invention, an appliance is registered with a hosted service by providing the hosted service with a unique identifier associated with the appliance in a first communications session; providing the appliance with a human readable pass phrase that is at least temporarily uniquely associated with the unique identifier; and providing the pass phrase to the hosted service as part of a second communications session during which registration will be completed.

### BRIEF DESCRIPTION OF THE DRAWINGS

The above and other features and advantages of the present invention are hereinafter described in the following detailed description of illustrative embodiments to be read in conjunction with the accompanying drawings, wherein like reference numerals are used to identify the same or similar system parts and/or method steps, and in which:

FIG. 1 illustrates signals exchanged among a set-top appliance, a hosting server and a third PC according to one embodiment of the invention.

FIG. 2 illustrates various fields of an example database entry maintained by the hosting service, according to an embodiment of the present invention.

FIG. 3 illustrates a flow graph of the algorithmic steps taken by the hosting service to create and destroy pass phrases for embodiments of the present invention.

### DETAILED DESCRIPTION

Reference is now made to the drawings wherein like numerals refer to like parts throughout. Described herein are methods and apparatus for associating a set-top appliance with a service. The present invention overcomes the limitations of above-described conventional services; in part by providing a user friendly pass phrase for service association. In one embodiment, a computer program adapted to run on a network accessible server to generate a pass phrase from a database (e.g., dictionary of words and/or phrases) is used to facilitate service association.

As used herein, the terms “hosted service” and “service” are used substantially similarly, and are meant to include any subscription-based service provided to customers thereof. Without limitation, hosted services include Web-based services offering video on demand or like content downloads, cable and/or satellite television services, telephone (wireless and/or wireline) services, and Internet services. In some embodiments, other Web-based services may be at issue, for example those offered by application service providers to individuals or enterprises.

As used herein, the term “server” is meant to include network-side server resources of a hosted service in the form of a computing platform, including content servers, billing system servers, web interface servers, the network operator's management servers, and so on.

As used herein, the term “device ID” is meant to include a computer readable sequence of bits, characters, alphanumeric string, etc. that uniquely identifies a device. The device ID is often, though not necessarily, a relatively long alphanumeric character string or a hexadecimal number that a human user may find difficult to remember (or even locate) during a device installation process. In some cases, the device ID may be unknown to the user, for example where the device ID is a Mac address or similar identifier that is retained in a computer readable medium but not otherwise printed or made visible to a user.

As used herein, the terms “operator” and “service providers” are used substantially similarly, and are meant to refer to an entity, other than a home or end-user, involved in manufacturing, design, deployment or maintenance of a system embodying the present invention, including but not limited to cable system operators, satellite providers, DSL internet providers, content providers, client device manufacturers, etc. as appropriate.

As used herein, the term “content” refers to audio, video, graphics files (in uncompressed or compressed format), icons, software, text files and scripts, data, binary files and other computer-usable data used to operate a client device and produce desired audio-visual effects on a client device for the viewer.

As used herein, the terms “computer-implemented method,” “computer program”, “routine,” and “subroutine” are substantially synonymous, with “computer method” being used typically (but not exclusively) to describe collections or groups of the latter two elements. Such programs and routines/subroutines may be rendered in any language including, without limitation, C#, C/C++, Fortran, COBOL, PASCAL, assembly language, markup languages (e.g., HTML, SGML, XML, VoXML), and the like, as well as object-oriented environments such as the Common Object Request Broker Architecture (CORBA), Java™ and the like. In general, however, all of the aforementioned terms as used herein are meant to encompass any series of logical steps performed in a sequence to accomplish a given purpose.

In view of the above, it should be appreciated that some portions of the detailed description that follows are presented in terms of algorithms and symbolic representations of operations on data within a computer memory. These algorithmic descriptions and representations are the means used by those skilled in the computer science arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers or the like. It should be borne in mind, however, that all of these and similar terms are to be associated with the appropriate physical quantities and are merely convenient labels applied to these quantities. Unless specifically stated otherwise, it will be appreciated that throughout the description of the present invention, use of terms such as “processing”, “computing”, “calculating”, “determining”, “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention can be implemented with an apparatus to perform the operations described herein. This apparatus may be specially constructed for the required purposes, or it may comprise a general-purpose computer, selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and processes presented herein are not inherently related to any particular computer or other apparatus. Various general-purpose systems may be used with programs in accordance with the teachings herein, or it may prove convenient to construct more specialized apparatus to perform the required method. For example, any of the methods according to the present invention can be implemented in hard-wired circuitry, by programming a general-purpose processor or by any combination of hardware and software. One of ordinary skill in the art will immediately appreciate that the invention can be practiced with computer system configurations other than those described below, including hand-held devices, multiprocessor systems, microprocessor-based or programmable consumer electronics, DSP devices, network PCs, minicomputers, mainframe computers, and the like. The invention can also be practiced in distributed computing environments where tasks are performed by remote processing devices that are linked through a communications network. The required structure for a variety of these systems will appear from the description below.

The methods of the present invention may be implemented using computer software. If written in a programming language conforming to a recognized standard, sequences of instructions designed to implement the methods can be compiled for execution on a variety of hardware platforms and for interface to a variety of operating systems. In addition, the present invention is not described with reference to any particular programming language. It will be appreciated that a variety of programming languages may be used to implement the teachings of the invention as described herein. Furthermore, it is common in the art to speak of software, in one form or another (e.g., program, procedure, application, etc.), as taking an action or causing a result. Such expressions are merely a shorthand way of saying that execution of the software by a computer causes the processor of the computer to perform an action or produce a result.

Overview

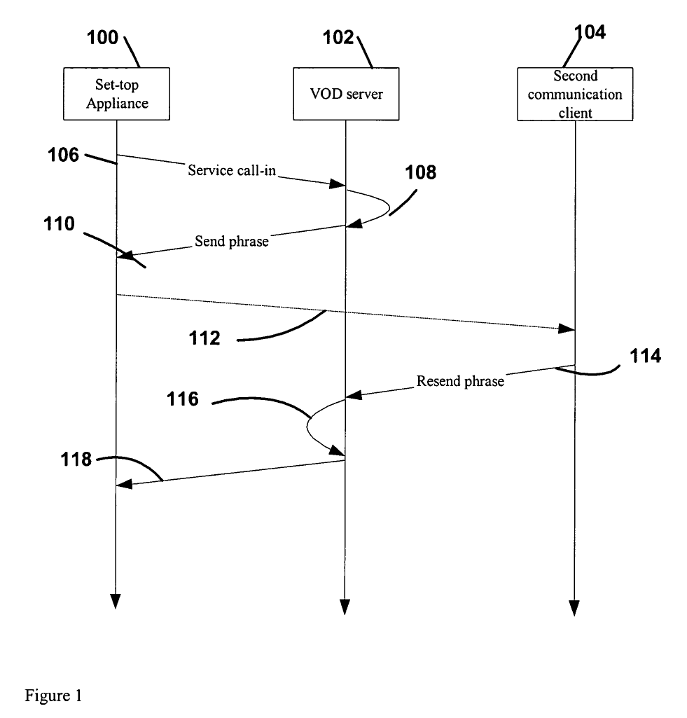

The present invention provides for associating a service (e.g., a hosted service) with a device (e.g., a set-top appliance or similar consumer product). This association process includes communication of a device ID by the device to a server or other computer resource associated with the service, dispatch of a pass phrase by the server to the device and subsequent use of this pass phrase (e.g., during a device installation process) to complete the service association. An exemplary embodiment is performed in steps as shown in FIG. 1.

In FIG. 1, three entities are shown exchanging messages among themselves. The device that is to be associated with a service is shown as 100. A server belonging to the service is shown as 102. A second device under the user's control that is used to communicate the pass phrase to the server 102 is shown as 104. In one embodiment, the device 100 could be a set-top appliance designed to download VOD content via its Internet connection and 104 could be a PC used by the user to communicate with the VOD subscription service over the Internet.

Assume for the moment that the user has recently purchased a subscription to the VOD service and that part of that purchase involved receipt of the device 100. Device 100 is to be the means by which content purchased by the user is downloaded to the user's home and subsequently played back for viewing. As this is the first time the new device is being associated with the VOD service, the device will need to be registered with the service so that the service knows to associate the new user's account with the newly installed device.

In step 108, the server adds the new device 100 (based on its device ID) to a database, creates a pass phrase and sends it back to the device as message 110. This pass phrase is communicated to a second device in step 112. In one exemplary embodiment, this step is performed by displaying the pass phrase on a television monitor connected to the device 100 so that the user can read it and input it to the second device. The rest of the service association is then finished by exchanging messages between the second device and the server including—step 114 to communicate back the phrase to the server, step 116 wherein the server matches the phrase received in step 114 with the phrase it had sent out in step 110. If there is a match, the requested service is associated with the ID of device 100 and a message of successful completion 118 is sent to the device

### Description of Exemplary Embodiments

Exemplary embodiments of the method and apparatus of the present invention are now described in detail.

Initial Communication

When first installed, the device must identify itself to a server associated with the hosted service. According to an embodiment of the present invention, this is done via the Internet. During manufacture, the device may be fashioned with a hard coded server IP address or a hard coded Domain Name Server (DNS) address to be used when initially contacting the VOD server. In one embodiment, the hard coded IP address may be used only one time, after which the client device may be provided with DNS names it should use during further communication with the VOD server. Other ways to initiate such a first communication with the service provider may exist but do not change scope of the present invention. This first call-in process preferably includes sending a message identifying the device and its network location to the server. In one exemplary embodiment, the first message sent by a device to the service includes the device ID that is used for subsequent service association.

Device ID Database

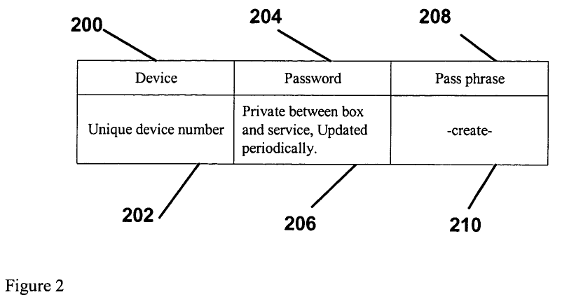

When the server responsible for managing service associations receives an indication of the presence of a new device, it adds the device to a database of all known devices on the service provider's network. In an exemplary embodiment, an entry as shown in FIG. 2 is created for a new device. This includes a device index field (200), a password field (202) and a pass-phrase field (204) for each device. In the device index field, each device is identified by its unique ID (206) sent by the device to the server. The optional password field (208) contains a password generated by the server and sent to the device for securing communication between the server and the device. The pass phrase field (210) contains a easy-to-remember pass phrase created for use during the service association steps described below. This phrase may be unique for each device or a library of such phrases may be periodically recycled once service association of a device is completed.

Creation of a Pass Phrase

In the preferred embodiment of the invention, the pass phrase is constructed in adjective-adjective-noun format (for example, “big pink cat” or “ferocious round crayfish”). Alternatively, the pass phrase may be formatted in any manner that will be relatively easy for a human being to remember for the time it takes to complete the device registration process for establishment of service. The pass phrase is created without duplication within pass phrases that are currently held active in the device ID database.

Establishment of Service

This step typically involves communication with the service provider to create an account for the user, selection of various preferences, options, payment plans, and so on. According to an embodiment of the invention, service is established via a secure web connection to the service provider's servers. In one step of the service establishment, the user is prompted for the pass phrase that uniquely identifies the device with which the user wants to associate the service. As described herein, this pass phrase is preferably a user-friendly phrase that can be easily remembered by the user.

Life Time of the Pass Phrase

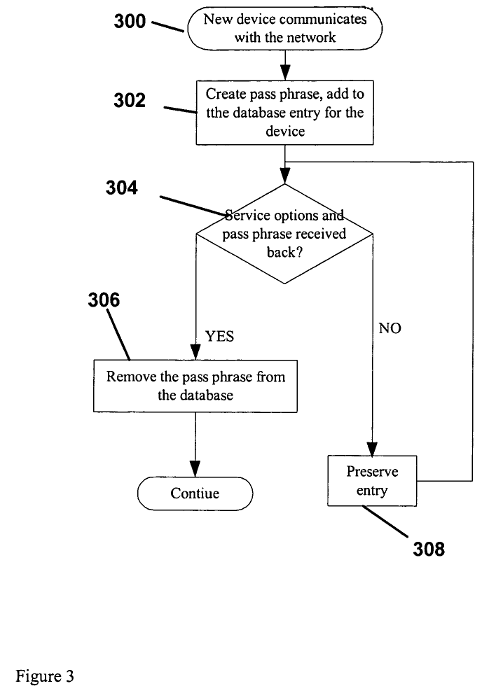

The life cycle of a pass phrase is shown in FIG. 3. When a new device appears on the network (300), a pass phrase is created and associated with it in the device ID database (302). During a user's service establishment transaction, s/he is prompted to enter this pass phrase (which has been communicated via the device). When the pass phrase is received by the server (304) during the user's service establishment transaction, the pass phrase ceases to be useful. Depending on the service provider's preference, this pass phrase may either be recycled so that it can be used another time or never used again. In some cases, the pass phrases are generated in a pseudorandom fashion when new devices identify themselves to the service so the possibility exists that such phrases will be used multiple times by different users or even by the same user in connection with different devices. So long as the same pass phrase cannot be generated for use in connection with different devices at the same time, this reuse does not compromise the ability to uniquely associate a particular device with a particular user's subscription. In one embodiment to ensure this uniqueness is maintained, for the duration for which the server has not received pass phrase from the user (306), the phrase is held in the device ID database and cannot be reused. In another embodiment, a separate database of allocated phrases could be maintained.

In the foregoing specification, the invention has been described with reference to specific exemplary embodiments thereof. It will, however, be evident to those of ordinary skill in the art that various modifications and changes may be made thereto without departing from the broader spirit and scope of the invention as set forth in the appended claims. The specification and drawings are, accordingly, to be regarded in an illustrative rather than a restrictive sense and that it understood that the following claims including all equivalents are intended to define the scope of the invention.

What is claimed is:

1. A method, comprising associating a set-top appliance identifiable with a unique identification number with a hosted service through which Internet content is available for download to the set-top appliance using a pass phrase automatically generated from a database and provided to a customer of the hosted service via the set-top appliance.

2. The method of claim 1, wherein the database comprises a dictionary of words and/or phrases.

3. The method of claim 1, wherein the pass phrase is organized as adjective-adjective-noun.

4. The method of claim 1, wherein the pass phrase is provided to the customer when the set-top appliance makes initial contact with a server associated with the hosted service.

5. The method of claim 4, wherein when the set-top appliance makes initial contact with the server, the set-top appliance identifies itself using the unique identification number.

6. The method of claim 5, wherein the server responds to the set-top appliance identifying itself, in part by issuing the pass phrase to be displayed to the customer via a display device coupled to the set-top appliance.

7. The method of claim 6, wherein the set-top appliance is associated with the hosted service after entry of the pass phrase via a user interface to the hosted service.

8. The method of claim 7, wherein the user interface to the hosted service comprises one or more Web pages accessible via a Web browser not associated with the set-top appliance.

9. The method of claim 1, wherein the set-top appliance is associated with the hosted service after entry of the pass phrase via a communication channel to the hosted service other than that used between the set-top appliance and a server from which the pass phrase is issued.

10. A method, comprising establishing a first communication session between a set-top appliance and a hosted service using a unique identifier associated with the set-top appliance; and establishing a second communication session between the hosted service and a customer thereof using a pass phrase provided to the customer as part of the first communication session.

11. The method of claim 10, wherein the pass phrase comprises a human readable phrase.

12. The method of claim 11, wherein the pass phrase is reusable by the hosted service upon completion of the second communication session.

13. The method of claim 11, wherein the pass phrase is organized as adjective-adjective-noun.

14. The method of claim 11, wherein the pass phrase is provided to the customer via a display device communicatively coupled to the set-top appliance.

15. The method of claim 11, wherein the pass phrase is stored on a computer readable medium at the set-top appliance at least until completion of the second communication session.

16. The method of claim 15, wherein the set-top appliance is advised of the completion of the second communications session via the hosted service.

17. A method of registering an appliance with a hosted service, comprising providing the hosted service with a unique identifier associated with the appliance in a first communications session; providing the appliance with a human readable pass phrase that is at least temporarily uniquely associated with the unique identifier; and providing the pass phrase to the hosted service as part of a second communications session during which registration will be completed.

18. The method of claim 17, wherein the pass phrase is provided to the hosted service by a human customer thereof using a Web-based user interface for the hosted service.

19. The method of claim 17, wherein the pass phrase is generated using a dictionary of terms and is arranged as adjective-adjective-noun.

20. The method of claim 17, wherein upon completion of the second communication session the pass phrase is no longer uniquely associated with the unique identifier.

21. The method of claim 20, wherein the appliance comprises a set-top box configured to download multimedia content available through the hosted service and further comprising presenting the pass phrase to a human user of the appliance via a display device coupled to the appliance.
